(19) United States
(12) Patent Application Publication
(10) Pub. No.: US 2017/0019200 A1
(43) Pub. Date: Jan. 19, 2017

(54) RECEPTION DEVICE, METHOD FOR CONTROLLING SAME, PROGRAM, AND RECORDING MEDIUM

(71) Applicant: Panasonic Intellectual Property Management Co., Ltd., Osaka (JP)

(72) Inventor: TAKASHI TAJIMA, Osaka (JP)

(73) Assignee: Panasonic Intellectual Property Management Co., Ltd., Osaka (JP)

(21) Appl. No.: 15/124,054

(22) PCT Filed: Mar. 23, 2015
(86) PCT No.: PCT/JP2015/001606

§ 371 Date: Sep. 7, 2016

(30) Foreign Application Priority Data
Mar. 27, 2014 (JP) 2014-065176

(51) Int. Cl. H04H 60/70; G01C 21/36; G08G 1/0962; H04H 60/43

(52) U.S. Cl. CPC H04H 60/70; H04H 60/43; G01C 21/367; G08G 1/0962

(57) ABSTRACT

A receiving device includes a receiver that receives one or more map images, a tuning-information storage unit, a tuning screen generator, a display unit, and a tuning unit. The tuning-information storage unit stores the one or more map images and one or more frequency information segments received from one or more broadcast stations such that each of the one or more map images is linked to respective one of the one or more frequency information segments. Each of the one or more frequency information segments indicates a frequency of respective one of the one or more broadcast stations. The tuning screen generator generates a tuning screen displaying thereon the one or more broadcast stations with the one or more frequency information segments stored in the tuning-information storage unit and with the one or more map images linked to the one or more frequency information segments. The display unit displays the tuning screen. The tuning unit tunes a broadcast station out of the one or more broadcast stations received by the receiver from the tuning screen displayed on the display unit. This receiving device does not include map data; however, allows a user to tune the broadcast station based on the map image by utilizing received data of a data broadcast.

### TECHNICAL FIELD

The present invention relates to a receiving device that receives a data broadcast including a map image information segment.

### BACKGROUND ART

A navigation device is known as a conventional receiving device that receives a data broadcast. The navigation device displays service areas of broadcast stations on a map image possessed in the navigation device from contents received from data broadcasts, and enables a user to select a broadcast station based on the service areas displayed on the map image (refer to, e.g. PTL 1).

However, a receiving device that does not include map data prevents a user from tuning the broadcast station based on a map image.

### CITATION LIST

### Patent Literature

PTL 1: Japanese Patent No. 4102952

### SUMMARY

A receiving device includes a receiver that receives one or more map images, a tuning-information storage unit, a tuning screen generator, a display unit, and a tuning unit. The tuning-information storage unit stores the one or more map images and one or more frequency information segments received from one or more broadcast stations such that each of the one or more map images is linked to respective one of the one or more frequency information segments. Each of the one or more frequency information segments indicates a frequency of respective one of the one or more broadcast stations. The tuning screen generator generates a tuning screen displaying thereon the one or more broadcast stations with the one or more frequency information segments stored in the tuning-information storage unit and with the one or more map images linked to the one or more frequency information segments. The display unit displays the tuning screen. The tuning unit tunes a broadcast station out of the one or more broadcast stations received by the receiver from the tuning screen displayed on the display unit.

Another receiving device includes a receiver, a scanning controller, a tuning-information storage unit, a tuning screen generator, a display unit, and a tuning unit. The receiver receives one or more broadcasts including one or more map image information segments, respectively. The scanning controller controls the receiver such that the receiver sequentially changes a receiving frequency received by the receiver and sequentially receives one or more broadcast stations. The tuning-information storage that stores the one or more map image information segments and one or more frequency information segments each indicating a frequency of respective one of the one or more broadcast stations received by the receiver controlled by the scanning controller, such that each of the one or more map image information segments is linked to respective one of the one or more frequency information segments. The tuning screen generator generates a tuning screen displaying thereon the one or more broadcast stations with at least one frequency information segment out of the one or more frequency information segments and with one or more map images respectively based on the one or more map image information segments out of groups of the one or more frequency information segments of the one or more broadcast stations and the one or more map image information segments stored in tuning-information storage unit. The display unit displays the tuning screen. The tuning unit tunes a broadcast station out of the one or more broadcast stations on the tuning screen displayed on the display unit.

These receiving devices do not include map data, but allows a user to tune the broadcast station based on the map image by utilizing data received from a data broadcast.

### BRIEF DESCRIPTION OF DRAWINGS

FIG. 1 is a block diagram of a receiving device in accordance with Exemplary Embodiment 1.

FIG. 2 shows a structure of data transmitted from a broadcast station in accordance with Embodiment 1.

FIG. 3 is a flowchart showing a scanning process of the receiving device in accordance with Embodiment 1.

FIG. 4 is a table showing tuning information of the receiving device in accordance with Embodiment 1.

FIG. 5 is a table showing a tuning screen of the receiving device in accordance with Embodiment 1.

FIG. 6A shows a transition of a display screen of the receiving device in accordance with Embodiment 1.

FIG. 6B shows a display screen of the receiving device in accordance with Embodiment 1.

FIG. 6C shows a display screen of the receiving device in accordance with Embodiment 1.

FIG. 6D shows a display screen of the receiving device in accordance with Embodiment 1.

FIG. 6E shows a display screen of the receiving device in accordance with Embodiment 1.

FIG. 6F shows a display screen of the receiving device in accordance with Embodiment 1.

FIG. 7A shows a display screen of the receiving device in accordance with Embodiment 1.

FIG. 7B shows a display screen of the receiving device in accordance with Embodiment 1.

FIG. 7C shows a display screen of the receiving device in accordance with Embodiment 1.

FIG. 7D shows a display screen of the receiving device in accordance with Embodiment 1.

FIG. 8 is a block diagram of a receiving device in accordance with Exemplary Embodiment 2.

FIG. 9 shows a receiver controlled by a scanning controller of the receiving device in accordance with Embodiment 2.

FIG. 10 is a block diagram of a receiving device in accordance with Exemplary Embodiment 3.

FIG. 11 is a table showing tuning information of the receiving device in accordance with Embodiment 3.

FIG. 12 shows a tuning screen of the receiving device in accordance with Embodiment 3.

FIG. 13 shows a reduction process performed by a tuning screen generator of the receiving device in accordance with Embodiment 3.

FIG. 14 shows the reduction processing performed by the tuning screen generator of the receiving device in accordance with Embodiment 3.

FIG. 15 is a block diagram of a receiving device in accordance with Exemplary Embodiment 4.

FIG. 16 shows a tuning screen of the receiving device in accordance with Embodiment 4.

FIG. 17 shows a reduction processing performed by a tuning screen generator of the receiving device in accordance with Embodiment 4.

FIG. 18 shows the reduction processing performed by the tuning screen generator of the receiving device in accordance with Embodiment 1.

FIG. 19 shows another tuning screen of the receiving device in accordance with Embodiment 4.

### DETAIL DESCRIPTION OF PREFERRED EMBODIMENTS

A description is made below of respective exemplary embodiments of the present invention while referring to the drawings. Note that the exemplary embodiments of the present invention, which will be described below, illustrate preferable specific examples of the present invention. Numeric values, shapes, constituents, and arrangement and connection mode of the constituents, which will be shown in the exemplary embodiments, are merely examples, and are not intended to limit the present invention. The present invention is limited only by claims. Hence, among the constituents in the following exemplary embodiments, constituents which are not described in independent claims are not necessarily necessary to achieve the object of the present invention; however, are described as those which compose more preferable forms.

### Exemplary Embodiment 1

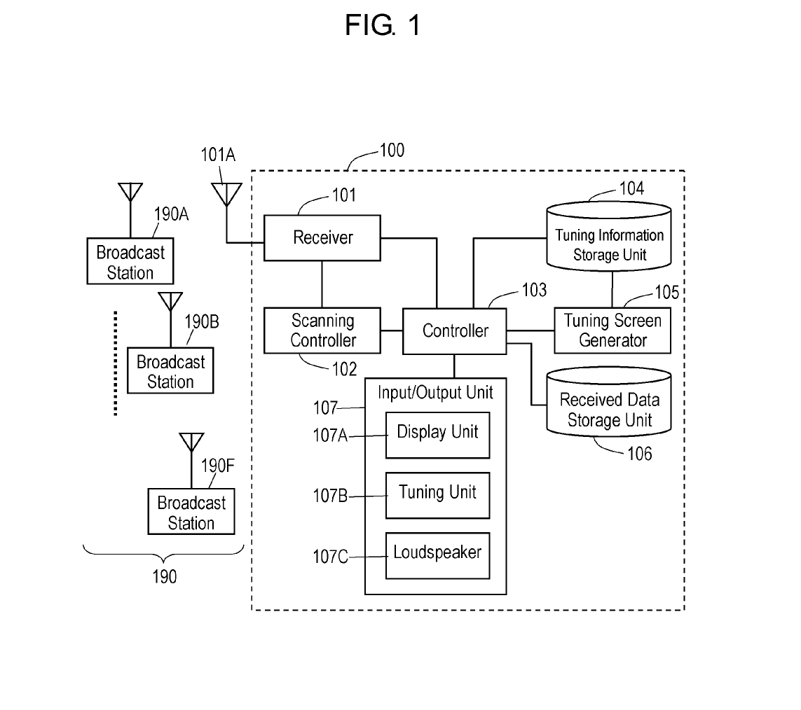

FIG. 1 is a block diagram of receiving device 100 in accordance with Exemplary Embodiment 1 for illustrating a configuration of receiving device 100 and a receiving environment around receiving device 100.

In FIG. 1, broadcast stations 190 including broadcast stations 190A, 190B . . . , 190F, . . . are receivable by receiving device 100. Broadcast stations 190 perform, in accordance with predetermined formats, a data broadcast, an audio broadcast, and a broadcast having the data broadcast and the audio broadcast multiplexed with each other.

In accordance with Embodiment 1, at least one of broadcast stations 190 performs a data broadcast including a map image information segment.

As shown in FIG. 1, receiving device 100 includes receiver 101, scanning controller 102, controller 103, tuning-information storage unit 104, tuning screen generator 105, received-data storage unit 106, and input/output unit 107. An antenna 101A is connected to receiver 101. Upon tuning a broadcast station, receiver 101 receives the tuned broadcast station via antenna 101A. For example, upon tuning broadcast station 190B facing a frequency of 97.7 MHz, receiver 101 receives the broadcast station 190B. Receiving device 100 does not include map data.

Scanning controller 102 controls receiver 101 to allow receiver 101 to sequentially change a frequency received by receiver 101 and to sequentially receive receivable broadcast stations.

While not tuning a broadcast station, receiver 101 sequentially changes the receiving frequency and sequentially receives the receivable broadcast stations under control of scanning controller 102. Upon receiving a map image information segment from the broadcast station, receiver 101 produces a group including the received map image information segment and a frequency information segment that indicates a frequency of the received broadcast station, and stores the group in tuning-information storage unit 104.

Tuning-information storage unit 104 stores a tuning information segment. The tuning information segment relates to a broadcast station that transmits the map image information segment and is received by receiver 101. The tuning information segment includes a frequency information segment of the broadcast station and the map image information segment of the broadcast station.

Tuning screen generator 105 generates a tuning screen from the tuning information segment stored in tuning-information storage unit 104. The tuning screen includes the frequency information segment and a map image that is generated from the map image information segment received by receiver 101 and that indicates the broadcast station.

Received-data storage unit 106 stores data of, e.g. news and weather, which are received by receiver 101 for categories.

Input/output unit 107 includes display unit 107A and tuning unit 107B. Display unit 107A of input/output unit 107 includes a display panel, such as a liquid crystal display panel, having a display screen for displaying an image. Tuning unit 107B includes a touch panel disposed on the display panel, display unit 107A.

The tuning screen generated by tuning screen generator 105 is displayed on display unit 107A of input/output unit 107. In input/output unit 107, a touch operation by a user to the touch panel, tuning unit 107B, is detected. The frequency information segment that indicates the frequency of the broadcast station displayed on display unit 107A at a position touched by the user is output to controller 103. Input/output unit 107 further includes loudspeaker 107C that outputs sounds.

Controller 103 controls the above units of receiving device 100.

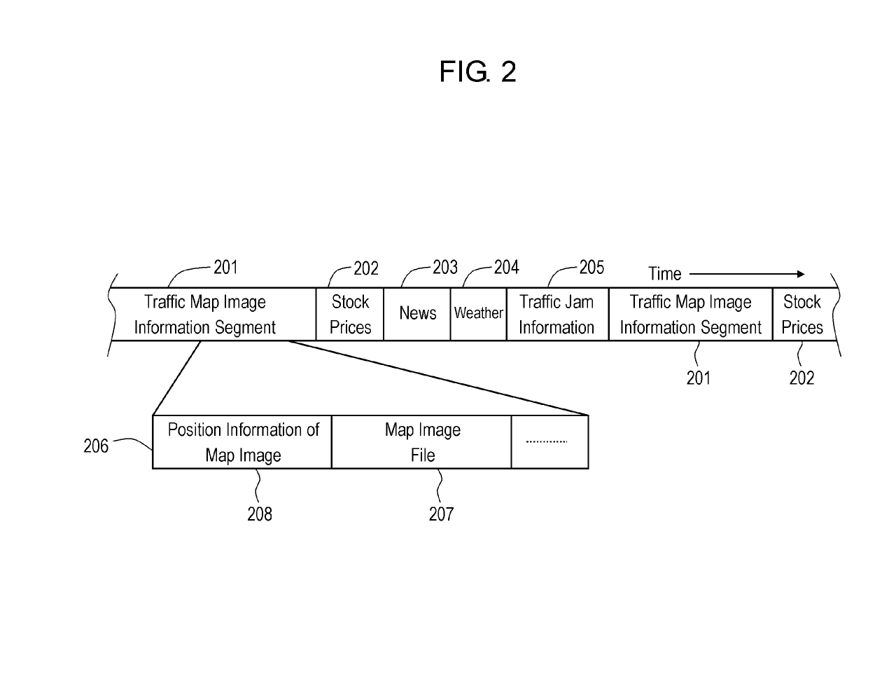

FIG. 2 shows a structure of data transmitted from the broadcast station that performs the data broadcast including the map image information segment.

The transmitted data includes traffic map image information segment 201, stock prices 202, news 203, weather 204, and traffic jam information 205. The transmitted data is updated as appropriate, and is repetitively transmitted. News 203, weather 204 and traffic jam information 205 relate to a particular region (hereinafter, referred to as a service area) indicated by traffic map image information segment 201. For example, information identifying the broadcast station, information indicating a time of updating the transmitted data, and information identifying the transmitted data are added to the transmitted data.

Traffic map image information segment 201 includes map image information segment 206. Map image information segment 206 includes map image file 207 that indicates a map image of the particular region and position information segment 208 of the map image which indicates the region of the map image. The map image indicated by map image file 207 includes a map image added with information, such as a map image added with the traffic jam information and a map image added with weather information. Types of the added information are identified by, e.g. identification information or a file name which is added to the file. The map image information segment includes a region name that is a name of the region shown in the map image.

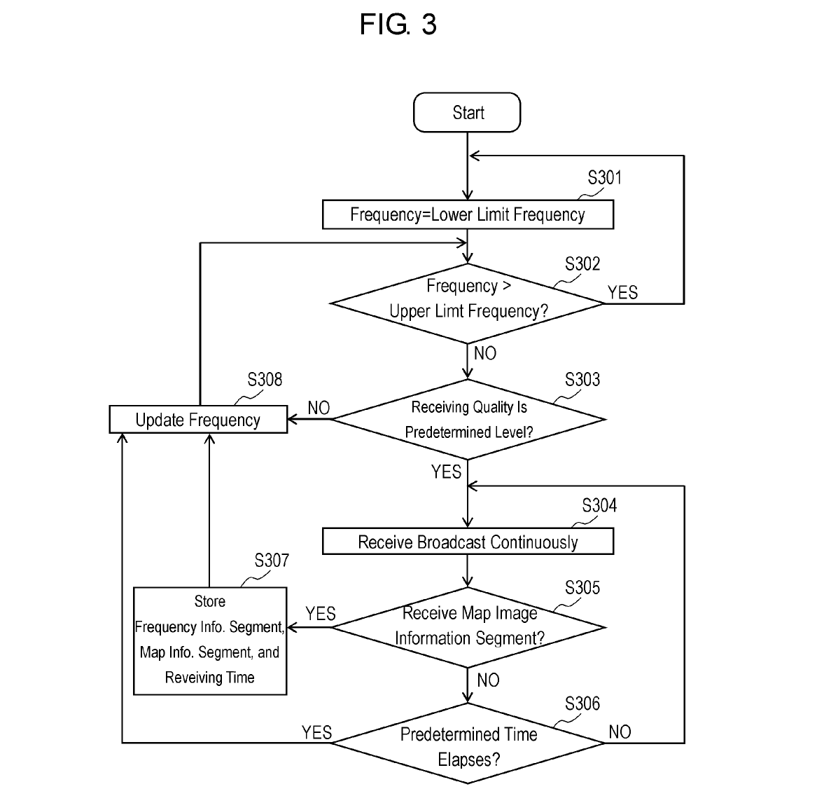

FIG. 3 is a flowchart illustrating a scanning process performed by scanning controller 102 and shows an operation of receiving device 100 particularly when not receiving a data broadcast.

Scanning controller 102 determines a frequency which is received by receiver 101 to be a lower limit frequency, for example, 87.5 MHz, receivable by receiver 101 (Step S301). Scanning controller 102 determines whether or not the determined frequency exceeds an upper limit frequency receivable by receiver 101 (Step S302).

In the case that the frequency determined at Step S302 does not exceed the upper limit frequency receivable by receiver 101 (“NO” in Step S302), receiver 101 can receive the determined frequency. Receiver 101 determines a receiving quality, a quality of a signal received by receiver 101, at the determined frequency with a quality value that indicates the receiving quality (Step S303). In accordance with Embodiment 1, the quality value is a field intensity of the received signal. In the case that the quality value indicates that the receiving quality is better than a predetermined level, that is, in the case that the field intensity is equal to or more than a predetermined value, for example, 30 dBμV (“YES” in Step S303), scanning controller 102 determines that the broadcast station that performs the broadcast at the determined frequency is receivable by receiver 101. Scanning controller 102 allows receiver 101 to continuously receive the broadcast of the broadcast station at the determined frequency (Step S304).

Scanning controller 102 determines whether or not receiver 101 receives the map image information segment at the determined frequency (Step S305). In the case that receiver 101 receives the map image information segment (“YES” in Step S30), receiver 101 produces a group of the frequency information segment that indicates the set frequency and the received map image information segment, and stores the group as the tuning information segment in tuning-information storage unit 104 (Step S307).

In receiving device 100 in accordance with Embodiment 1, receiver 101 stores, in tuning-information storage unit 104, the frequency set as the frequency information segment and a broadcast station name that is a name of the broadcast station that performs the broadcast at the set frequency. Receiver 101 stores, in tuning-information storage unit 104, the map image file which shows a map image of the particular region as the map image information segment. The broadcast station receivable by receiver 101 may change depending on a time and the position of receiving device 100. Even if the frequency is the same, the broadcast station may change, and contents of the data broadcast may change.

Receiver 101 stores, in tuning-information storage unit 104, the tuning information segment together with a time at which the tuning information segment is received information segment so that tuning screen generator 105 can generate a newest tuning screen.

In the case that receiver 101 does not receive the map image information segment in Step S305 (“NO” in Step S305), scanning controller 102 repeats operations from Step S304 to Step S305 until a predetermined time, for example, one minute elapses (Step S306).

In the case that the predetermined time elapses in Step S306 (“YES” in Step S306), and that it is determined in Step S303 that the receiving quality is not higher than the predetermined level (for example, in the case that the field intensity is less than 30 dBμV), scanning controller 102 updates and determines the frequency to be received by receiver 101 (Step S308). Also in the case that the tuning information segment and the receiving time are stored in tuning-information storage unit 104 in Step S307, scanning controller 102 updates and determines, in Step S308, the frequency to be received by receiver 101.

For example, in the case that an increment of the updating of the frequency is 0.1 MHz, scanning controller 102 determines the frequency to be received by receiver 101 in Step S308 by adding 0.1 MHz to a current frequency, and then, determines in Step S302 whether or not the frequency exceeds the upper limit frequency.

In the case that it is determined in Step S302 that the determined frequency exceeds the upper limit of the frequency receivable by receiver 101 (“NO” in Step S302), then in Step S301, scanning controller 102 determines the frequency to be received by receiver 101 to the lower limit frequency, and starts the scanning process again.

The scanning process shown in FIG. 3 is started by, e.g. an instruction by the user and an instruction from controller 103, and is ended when receiver 101 starts receiving the data broadcast by the operation of the user.

While controller 103 determines whether or not receiver 101 receives the data broadcast, e.g. every predetermined time, in the case that receiver 101 does not receive a data broadcast, controller 103 instructs scanning controller 102 to start the scanning process.

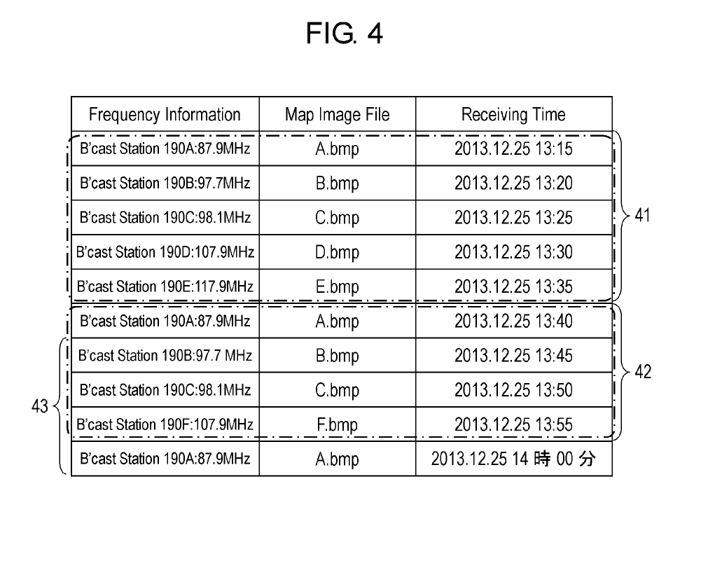

FIG. 4 shows the tuning information segments acquired by the scanning process. The tuning information segments shown in FIG. 4 are stored in tuning-information storage unit 104.

FIG. 4 shows information segments relating to six broadcast stations 190A to 190F. Broadcast station group 41 shown in FIG. 4 shows that, the scanning process allows broadcast stations 190A, 190B, 190C, 190D, and 190E to be stored as the receivable broadcast stations in tuning-information storage unit 104.

Broadcast station group 42 shows that it is determined by next scanning process that broadcast station E cannot be received. Broadcast station group 42 shows that a broadcast station with a frequency of 107.9 MHz is changed from broadcast station 190D to broadcast station 190F, and that the broadcast station perform a data broadcast with different contents from those of broadcast station 190D.

Tuning screen generator 105 generates the tuning screen from the tuning information segment stored in tuning-information storage unit 104. Tuning screen generator 105 generates the tuning screen from the tuning information segment acquired by a newest scanning process. For example, tuning information segment shown in broadcast station group 43 shown in FIG. 4 is the tuning information segment acquired by the newest scanning process.

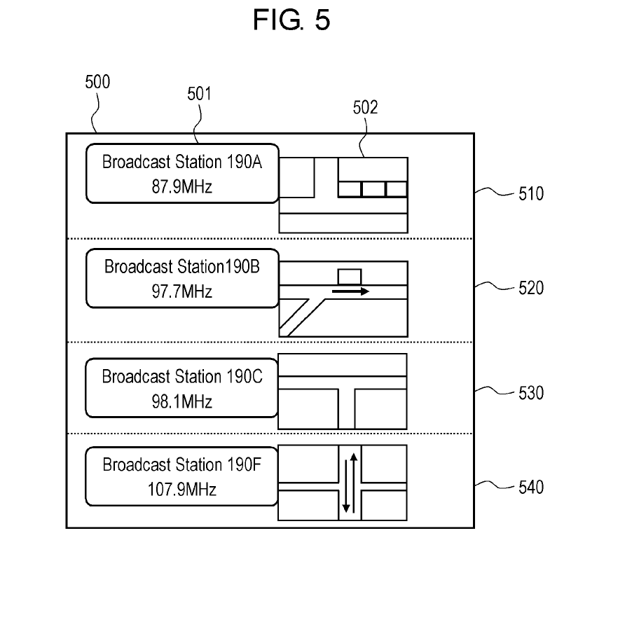

FIG. 5 shows the tuning screen generated by tuning screen generator 105.

Tuning screen generator 105 divides the display screen of display unit 107A of input/output unit 107 into one or more display regions, and displays the broadcast stations on the divided display regions. Each of the receivable broadcast stations is displayed on respective one of the display regions.

Tuning screen 500 includes four display regions 510, 520, 530, and 540.

One receivable broadcast station, for example, the broadcast station appearing in display region 510 is displayed with frequency information segment 501 and map image 502 generated from the map image information segment.

In tuning screen 500, arrows on map images displayed on display regions 520 and 540 indicate directions of traffic jam.

The frequency of the broadcast station displayed in the display region touched by the user is set by controller 103 as a receiving frequency to be received by receiver 101. Receiver 101 receives the broadcast station with the set frequency.

Next, an operation of receiving device 100 will be described below.

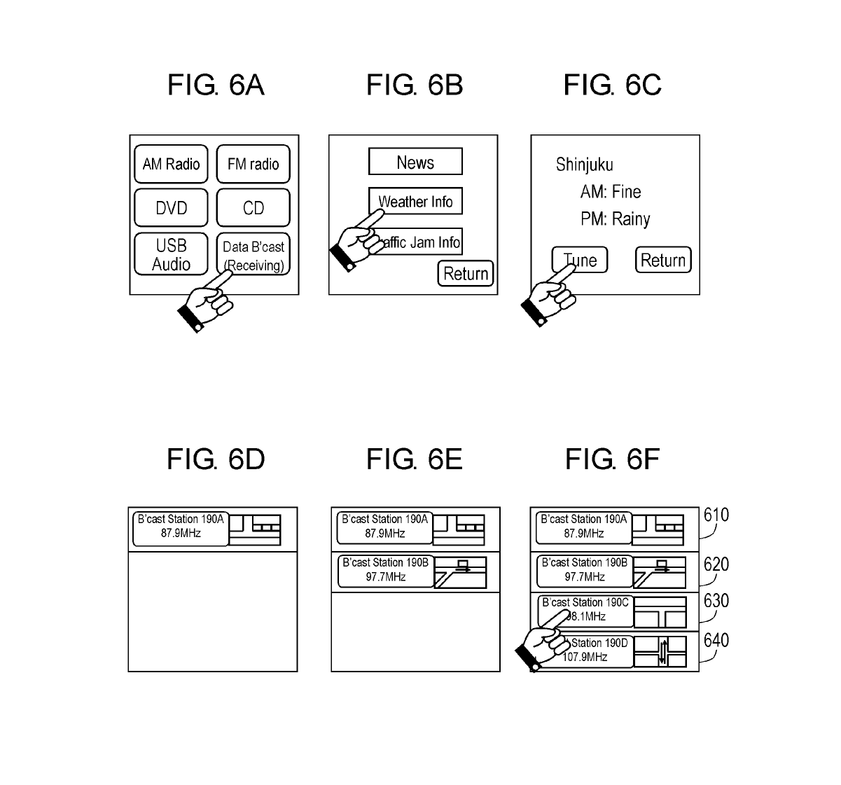

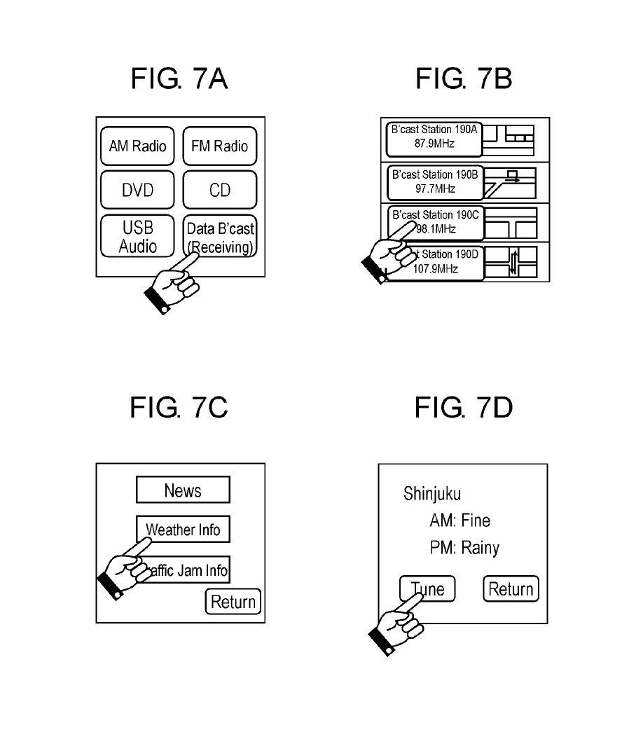

FIGS. 6A to 6F and 7A to 7D illustrate display screens of a display audio device having receiving device 100 according to Embodiment 1 installed therein. The display audio device is an on-vehicle device that does not include map data or a navigation function, but includes a display and an audio/visual (AV) function.

In operations shown in FIGS. 6A to 6F and 7A to 7D, input/output unit 107 of receiving device 100 also serves as an input/output unit of the display audio device. That is, the display screens shown in FIGS. 6A to 6F and 7A to 7D are display screens of display unit 107A of input/output unit 107 of receiving device 100.

The display screen shown in FIG. 6A displays indications of “AM Radio”, “FM Radio”, “DVD”, “CD”, “USB Audio” and “Data Broadcast (Receiving)”, and shows that the display audio device includes functions of a AM Radio, an FM Radio, a DVD, a CD, and a USB Audio as well as that of the data broadcast. The indication of “Data B′cast (Broadcast) (Receiving)” indicates that receiver 101 tunes a broadcast station.

When the user touches the indication of “Data Broadcast (Receiving)” on the display screen shown in FIG. 6A, the display screen of display unit 107A shifts to the display screen shown in FIG. 6B. The display screen shown in FIG. 6B displays indications of “News”, “Weather Info. (Information)” and “Traffic Jam Info. (Information)” to show that news, weather information, and traffic jam information are received from the broadcast station tuned by receiver 101. When the user touches the indication of “Weather Info.” on the display screen shown in FIG. 6B, the display screen of display unit 107A shifts to the display screen shown in FIG. 6C. This display screen displays indications of “Tune” and “Return”. When the user touches the indication of “Return”, the display screen of display unit 107A returns to the display screen shown in FIG. 6B, which is the previous display screen.

The display screen shown in FIG. 6C displays weather forecast in the morning and afternoon at a place of “Shinjuku”. FIG. 6C displays the indication of “Tune” together with the indication of “Return”. The indication of “Tune” instructs to display the tuning screen of receiver 101. The indication of “Return” instructs to return the display screen to the previous screen.

In the case that the user wants to know weather forecast at a place other than Shinjuku, when the user touches the indication of “Tune” on the display screen shown in FIG. 6C, the tuning of the received broadcast station in receiver 101 is released, and the scanning process shown in FIG. 3 is started. Every time when the tuning information segment is acquired by the scanning process, tuning screen generator 105 updates the tuning screen, and as shown in FIGS. 6D to 6F, displays the tuning screen on display unit 107A of input/output unit 107 every time of updating the tuning screen.

On the display screen shown in FIG. 6F, the user can tune, based on the map images which show the broadcast stations, the broadcast station out of the four broadcast stations displayed in display regions 610 to 640.

For example, when the user touches display region 630, input/output unit 107 outputs, to controller 103, the frequency of 98.1 MHz of broadcast station 190C displayed in display region 630 touched by the user. Controller 103 sets the receiving frequency of receiver 101 to 98.1 MHz, and tunes broadcast station 190C as the received broadcast station. The scanning process is stopped when the received broadcast station by receiver 101 is tuned. Receiver 101 receives broadcast station 190C tuned by controller 103.

FIGS. 7A to 7D show transitions of the display screens particularly from a state where receiver 101 does not tune the receivable broadcast station.

The indication of “Data B'cast (Receiving)” on the display screen shown in FIG. 7A indicates that receiver 101 does not tune the receivable broadcast station. In the case that the tuning screens shown in FIGS. 6D to 6F are displayed for a time not shorter than a predetermined time, and the touch operation of the user to the tuning screen is not detected, display unit 107A displays the display screen shown in FIG. 7A.

When the indication of “Data Broadcast (Select Station)” is touched on the display screen shown in FIG. 7A, the display screen shifts to the tuning screen shown in FIG. 7B. When the user tunes the broadcast station on the display screen shown in FIG. 7B based on the map images, and touches the screen, then controller 103 tunes the broadcast station displayed at a position touched by the user, as the broadcast station received by receiver 101.

Data received from the tuned broadcast station is stored in received-data storage unit 106. When the data is stored in received-data storage unit 106, the display screen shifts to the display screen shown in FIG. 7C.

The indication included in the display screen shown in FIG. 7C is touched, thereby displaying required information indicated by the indication, as shown in FIG. 7D.

As described above, in receiving device 100 according to Embodiment 1, in receiving device 100 that does not include map data, the user can tune the broadcast station based on the map images by utilizing the data received through the data broadcast.

Receiving device 100 in accordance with Embodiment 1 is not only implemented by dedicated hardware, but also by a program for executing the above-described control method recorded in a computer-readable recording medium and having a computer read the recorded program.

In receiving device 100 in accordance with Embodiment 1, the scanning process is controlled to shift to the next frequency after a predetermined time elapses. In receiving device 100 in accordance with Embodiment 1, in that case that receiver 101 detects that the map image information segment is included in the received data, receiver 101 may be controlled to shift to the next receiving of an airwave when the receiving of the map image information segment is completed. Moreover, input/output unit 107 may be implemented by an input unit and an output unit separated from each other. This configuration may be adopted so that a tuning screen displayed on the output unit can be selected and identified by the input unit, such as a button or a dial.

In accordance with Embodiment 1, the frequencies and the broadcast station names are displayed as the frequency information segment. But, only the frequencies or only the broadcast station names may be displayed. The frequency information segment allows controller 103 to uniquely identify each of the frequencies of the broadcast stations.

For example, in the case that the controller includes a correspondence table that shows correspondence between aliases of the broadcast station names and the frequencies, the frequency information segment may be only the aliases of the broadcast station names.

As described above, receiving device 100 does not include map data. Receiver 101 receives one or more map images. Tuning-information storage unit 104 stores the one or more map images and one or more frequency information segments received from one or more broadcast stations 190 such that each of the one or more map images is linked to respective one of the one or more frequency information segments. Each of the one or more frequency information segments indicates a frequency of respective one of the one or more broadcast stations 190. Tuning screen generator 105 generates a tuning screen displaying thereon the one or more broadcast stations 190 with the one or more frequency information segments stored in the tuning-information storage unit 104 and with the one or more map images linked to the one or more frequency information segments. Display unit 107A displays the tuning screen. Tuning unit tunes a broadcast station out of the one or more broadcast stations 190 received by the receiver 101 from the tuning screen displayed on the display unit 107A.

As mentioned above, receiver 101 receives one or more broadcasts including one or more map image information segments 206, respectively. Scanning controller 102 controls the receiver 101 such that the receiver 101 sequentially changes a receiving frequency received by the receiver 101 and sequentially receives one or more broadcast stations 190. Tuning-information storage unit 104 stores the one or more map image information segments 206 and one or more frequency information segments 501 each indicating a frequency of respective one of the one or more broadcast stations 190 received by the receiver 101 controlled by the scanning controller 102, such that each of the one or more map image information segments 206 is linked to respective one of the one or more frequency information segments 501. Tuning screen generator 105 generates a tuning screen displaying thereon the one or more broadcast stations 190 with at least one frequency information segment 501 out of the one or more frequency information segments 501 and with one or more map image information segments 206 respectively based on the one or more map image information segments 206 out of groups of the one or more frequency information segments 501 of the one or more broadcast stations 190 and the one or more map image information segments 206 stored in tuning-information storage unit 104.

### Exemplary Embodiment 2

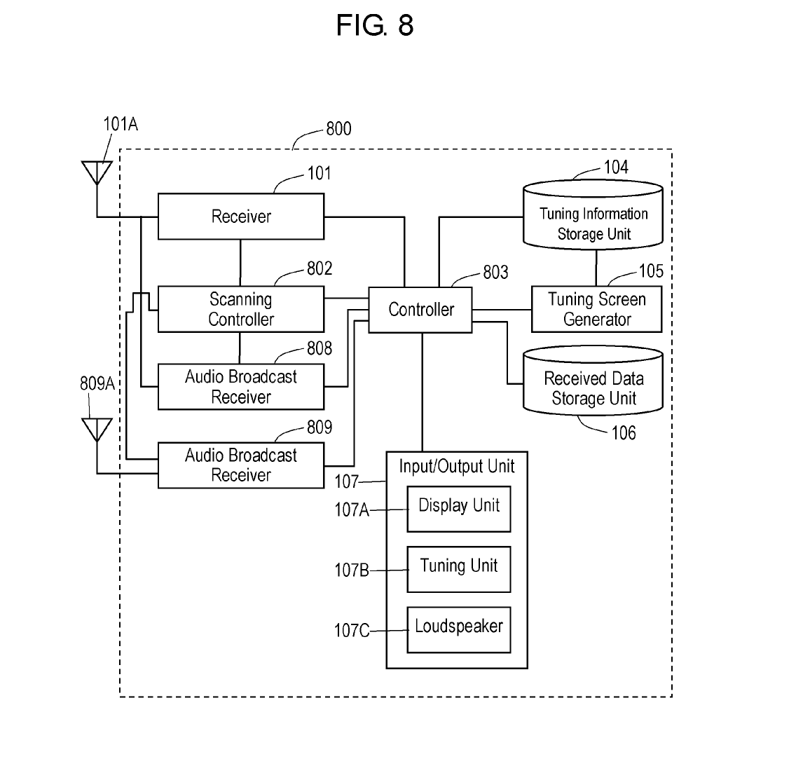

FIG. 8 is a block diagram of receiving device 800 in accordance with Exemplary Embodiment 2. In FIG. 8, components identical to those of the receiving device Embodiment 1 shown in FIG. 1 are denoted by the same reference numerals.

A difference of receiving device 800 in accordance with Embodiment 2 from that of Embodiment 1 is that receiving device 800 further includes audio broadcast receivers 808 and 809 which receive an audio broadcast, and is configured so that audio broadcast receivers 808 and 809 can perform the scanning process.

In FIG. 8, both of audio broadcast receivers 808 and 809 can receive an audio broadcast and a data broadcast. Audio broadcast receivers 808 and 809 are connected to antennas 101A and 809A different from each other, respectively.

Scanning controller 802 controls audio broadcast receivers 808 and 809 in addition to receiver 101.

An operation of receiving device 800 configured as above will be described below.

In the case that receiving device 800 receives an audio broadcast, controller 803 performs a diversity receiving by using audio broadcast receivers 808 and 809. The diversity receiving is a receiving method for reducing fading by synthesizing or switching plural received waves changing independently of each other.

In receiving device 800 in accordance with Embodiment 2, controller 803 selects an audio broadcast receiver out of audio broadcast receivers 808 and 809 which receives a wave having a larger field intensity, as an audio broadcast receiver that receives the audio broadcast. Input/output unit 107 outputs an audio signal supplied from the selected audio broadcast receiver, as a sound.

Based on a receiving state of receiving device 800, scanning controller 802 selects a receiver to be controlled out of receiver 101 and audio broadcast receivers 808 and 809, and allows the selected receiver to perform the scanning process.

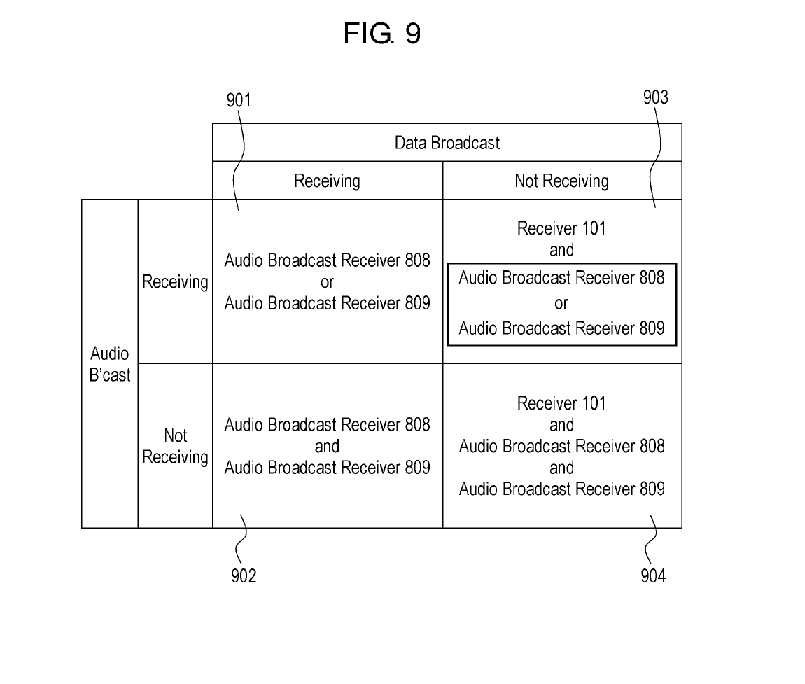

FIG. 9 shows the receiver controlled by scanning controller 802, that is, the receiver that performs the scanning process based on receiving states 901 to 904 of receiving device 800.

In the case that receiving device 800 receives the data broadcast and the audio broadcast (receiving state 901), scanning controller 802 determines, to be the receiver to be controlled, an audio broadcast receiver out of audio broadcast receivers 808 and 809 which is not selected by controller 803 as the receiver that receives the audio broadcast while scanning controller 802 determines, to be a receiver which is not to be controlled, an audio broadcast receiver out of audio broadcast receivers 808 and 809 and receiver 101 which is selected by controller 803 as the receiver that receives the audio broadcast. The audio broadcast receiver out of audio broadcast receivers 808 and 809 which is controlled by scanning controller 802 periodically detects the field intensity of the audio broadcast received by another audio broadcast receiver, and performs the scanning process shown in FIG. 3 in accordance with Embodiment 1. This scanning process stops when the field intensity of the audio broadcast periodically detected by the audio broadcast receiver controlled by scanning controller 802 becomes larger than the field intensity of the audio broadcast received by the other audio broadcast receiver to allow controller 803 to select the audio broadcast receiver to be controlled by scanning controller 802 as the audio broadcast receiver that receives the audio broadcast.

That is, in receiving state 901 where receiving device 800 receives the data broadcast and the audio broadcast, for example, in the case that quality values of signals received by audio broadcast receivers 808 and 809 indicate that receiving quality of the signal received by audio broadcast receiver 808 is better than receiving quality of the signal received by audio broadcast receiver 809, that is, in that case that a field intensity of the signal received by audio broadcast receiver 808 is larger than a field intensity of the signal received by audio broadcast receiver 809, controller 803 selects audio broadcast receiver 808 out of audio broadcast receivers 808 and 809 as the receiver to receive the audio broadcast. Scanning controller 802 determines audio broadcast receiver 809 audio broadcast receivers 808 and 809 which is not selected by controller 803 to be the receiver to be controlled to receive the audio broadcast, that is, the receiver to perform the scanning process shown in FIG. 3 in accordance with Embodiment 1. Audio broadcast receiver 809 out of audio broadcast receivers 808 and 809 which is controlled by scanning controller 802 periodically detects field intensities of the audio broadcasts received by audio broadcast receivers 808 and 809. The scanning process stops when the field intensity of the audio broadcast received by audio broadcast receiver 809 out of audio broadcast receivers 808 and 809 which performs the scanning process becomes larger than the field intensity of the audio broadcast received by audio broadcast receiver 808 and controller 803 selects audio broadcast receiver 808 which is controlled by scanning controller 802 as the audio broadcast receiver that receives the audio broadcast and performs the scanning process.

In the case that receiving device 800 receives the data broadcast and does not receive the audio broadcast (receiving state 902), scanning controller 802 controls audio broadcast receivers 808 and 809 to allow broadcast receivers 808 and 809 to perform the scanning process. Scanning controller 802 sets and stores an intermediate frequency that divides a frequency range receivable by receiver 101 into a low-frequency range and a high-frequency range.

A lower limit frequency of the low-frequency range is the lower limit frequency of the frequency range receivable by receiver 101 while an upper limit frequency of the low-frequency range is the intermediate frequency. A lower-limit frequency of the high-frequency range is the intermediate frequency while an upper limit frequency of the high-frequency range is the upper limit frequency of the frequency range receivable by receiver 101. In accordance with Embodiment 2, a width of the low-frequency range and a width of the high-frequency range are equal to each other, but may not be equal to each other. In the low-frequency range, scanning controller 802 allows one of audio broadcast receivers 808 and 809 to perform the scanning process. In the high-frequency range, scanning controller 802 allows the other of audio broadcast receivers 808 and 809 to perform the scanning process. That is, scanning controller 802 allows audio broadcast receiver 808 to perform the scanning process in the low-frequency range, and allows audio broadcast receiver 809 to perform the scanning process in the high-frequency range. Scanning controller 802 may allow audio broadcast receiver 809 to perform the scanning process in the low-frequency range, and may allow audio broadcast receiver 808 to perform the scanning process in the high-frequency range. This scanning process stops when receiving device 800 starts receiving the audio broadcast.

In the case that receiving device 800 does not receive the data broadcast but receives the audio broadcast (receiving state 903), scanning controller 802 determines receiver 101 and the audio broadcast receiver out of audio broadcast receivers 808 and 809 which is not selected as the receiver to receive the audio broadcast by controller 803 to be the receivers to be controlled by scanning controller 802. Similarly to receiving state 902, scanning controller 802 allows receiver 101 and the audio broadcast receiver out of audio broadcast receivers 808 and 809 which is not selected as the receiver receiving the audio broadcast by controller 803 and which is controlled by scanning controller 802 to perform the scanning process individually in the low-frequency range and the high-frequency range. At this moment, each of the audio broadcast receiver and receiver 101 which are controlled by scanning controller 802 may perform the scanning process in the high-frequency range and the low-frequency range. The audio broadcast receiver controlled by scanning controller 802 out of audio broadcast receivers 808 and 809 performs the scanning process, and in addition, detects the field intensity of the audio broadcast to be received while the other audio broadcast receiver periodically detects the field intensity of the audio broadcast that is received. This scanning process stops when the audio broadcast receiver controlled as the receiver receiving the audio broadcast by scanning controller 802 is selected by controller 803 by similar operations to the above-described operations in receiving state 901, or when the receiving of the data broadcast is started.

In that case that receiving device 800 does not receive either the data broadcast or the audio broadcast (receiving state 904), scanning controller 802 controls three receivers: receiver 101 and audio broadcast receivers 808 and 809 to allow receiver 101 and audio broadcast receivers 808 and 809 to perform the scanning process. Scanning controller 802 sets and stores a low-intermediate frequency and a high-intermediate frequency which divide the frequency range receivable by receiver 101 into a low-frequency range, a middle-frequency range, and a high-frequency range. A lower-limit frequency of the low-frequency range is the lower limit frequency of the frequency range receivable by receiver 101 while an upper-limit frequency of the low-frequency range is the low-intermediate frequency. A lower-limit frequency of the middle-frequency range is the low-intermediate frequency while an upper-limit frequency of the middle-frequency range is the high-intermediate frequency. A lower-limit frequency of the high-frequency range is the high-intermediate frequency while an upper-limit frequency of the high-frequency range is the upper limit frequency of the frequency range receivable by receiver 101. In accordance with Embodiment 2, a width of the low-frequency range, a width of the middle-frequency range, and a width of the high-frequency range are equal to one another, but may not be equal to one another. In the low-frequency range, scanning controller 802 allows one receiver out of the three receivers to perform the scanning process. In the middle-frequency range, scanning controller 802 allows another receiver out of the three receivers to perform the scanning process. In the high-frequency range, scanning controller 802 allows still another receiver out of the three receivers to perform the scanning process. These scanning processes stops when receiving device 800 starts receiving the data broadcast or the audio broadcast.

As described above, in the receiving device according to Embodiment 2, in the receiving device that does not include the map data, the user can select the broadcast station based on the map images by utilizing the received data of the data broadcast.

Audio broadcast receivers 808 and 809 can perform the scanning process, thereby acquiring and updating the tuning information segment while the data broadcast is received. Without waiting for the updating of the tuning screen, the user can select the broadcast station to receive the data broadcast based on the map image broadcasted by the broadcast station displayed on the tuning screen subsequently after the data broadcast is received.

In the receiving device according to Embodiment 2, a receiver dedicated for the scanning process can be omitted, and accordingly, cost is reduced, and the number of receivers can be suppressed, thereby lowering a failure rate.

Data, such as national news and stock prices, which are acquired during the scanning process and which relate not to the region shown by the map image is stored in received-data storage unit 106. This configuration allows information which is not acquirable by the broadcast station selected by the user to also be displayed. This configuration allows acquirable information to be displayed earlier since the information may not be still distributed from the broadcast station even if the information is acquirable.

Receiving device 800 in accordance with the embodiment is not only implemented by dedicated hardware, but may be implemented by a program for executing the above control method recorded in a computer-readable recording medium and by allowing a computer to read the recorded program.

As described above, audio broadcast receiver 808 (809) can receive the audio broadcast and the one or more broadcast each including the one or more map image information segments. Scanning controller 802 controls audio broadcast receiver 808 (809) to sequentially change the receiving frequency of broadcast receiver 808 (809), and to sequentially receive one or more broadcast stations 190. Tuning-information storage unit 104, under control of scanning controller 802, stores one or more map image information segments 206 and one or more frequency information segments 501 of one or more broadcast stations 190 received by audio broadcast receiver 808 (809) controlled by scanning controller 802 such that each of one or more map image information segments 206 is linked to respective one of one or more frequency information segments 501.

### Exemplary Embodiment 3

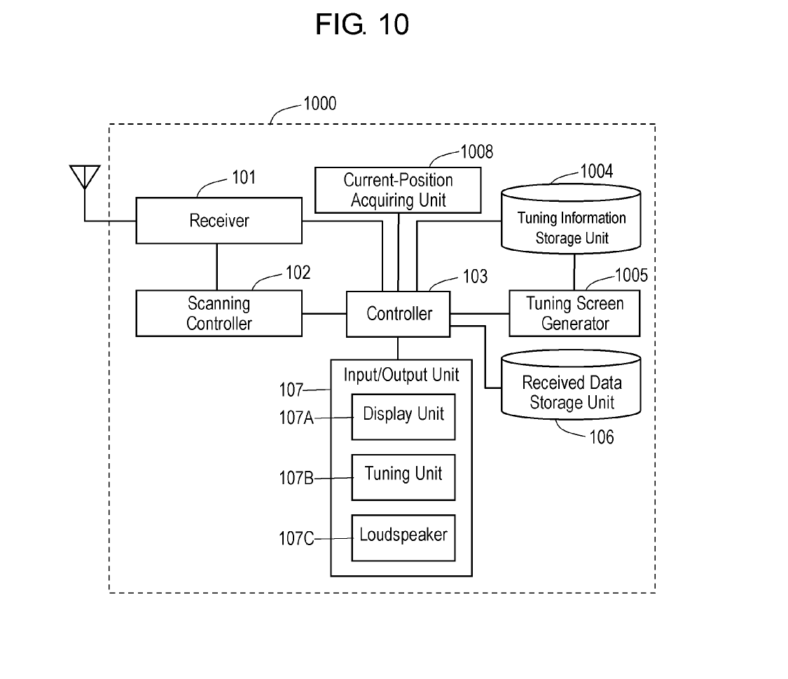

FIG. 10 is a block diagram of receiving device 1000 in accordance with Exemplary Embodiment 3. In FIG. 10, components identical to those of receiving device 100 according to Embodiment 1 shown in FIG. 1 are denoted by the same reference numerals.

Receiving device 1000 is different from the receiving device according to Embodiment 1 in that receiving device 1000 includes a current-position acquiring unit 1008, that receiver 1001 stores, in tuning-information storage unit 1004, the map image file together with as the map image information segment, a position information segment of the map image which indicates a region of the map image, and that tuning screen generator 1005 displays a selectable broadcast station with an image on which an icon is disposed in which the icon indicates the map image and the current position based on the frequency information segment, the position information segment of the map image, and the current position.

In FIG. 10, upon receiving the map image information segment in the scanning process, receiver 1001 stores, as the tuning information segment, the position information segment of the map image together with the map image file in tuning-information storage unit 1004. The position information segment indicates the region of the map image indicated by the map image file. For example, in the case that the map image has a rectangular shape, the position information segment of the map image includes latitudes and longitudes of vertexes of the rectangular shape.

Current-position acquiring unit 1008 includes, e.g. a Global Positioning System (GPS), and acquires a current position information segment indicating the current position of receiving device 1000, thereby acquires the current position of receiving device 1000.

Tuning screen generator 1005 generates the tuning screen based on the tuning information segment stored in tuning-information storage unit 1004 and the current position acquired by current-position acquiring unit 1008, and displays the generated tuning screen on display unit 107A of input/output unit 107.

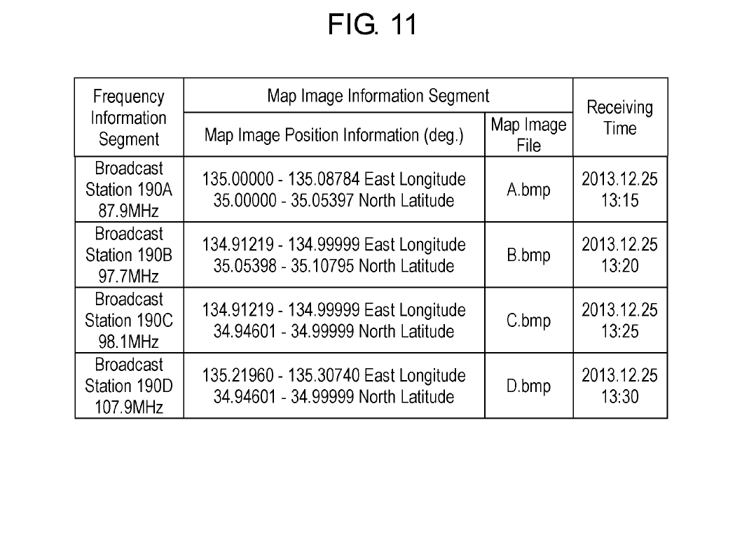

FIG. 11 shows the tuning information segment of receiving device 1000 in accordance with Embodiment 3. The tuning information segment is stored in tuning-information storage unit 1004. FIG. 11 shows that map image file “A.bmp” received from broadcast station 190A is a map image showing a rectangular region having vertexes located at 135.00000 degrees east longitude, 135.08784 degrees east longitude, 35.00000 degrees north latitude, and 35.05397 degrees north latitude.

Tuning screen generator 1005 acquires the current position of receiving device 1000 from current-position acquiring unit 1008 when generating the tuning screen, and generates the tuning screen from the acquired current position and the tuning information segment stored in tuning-information storage unit 1004.

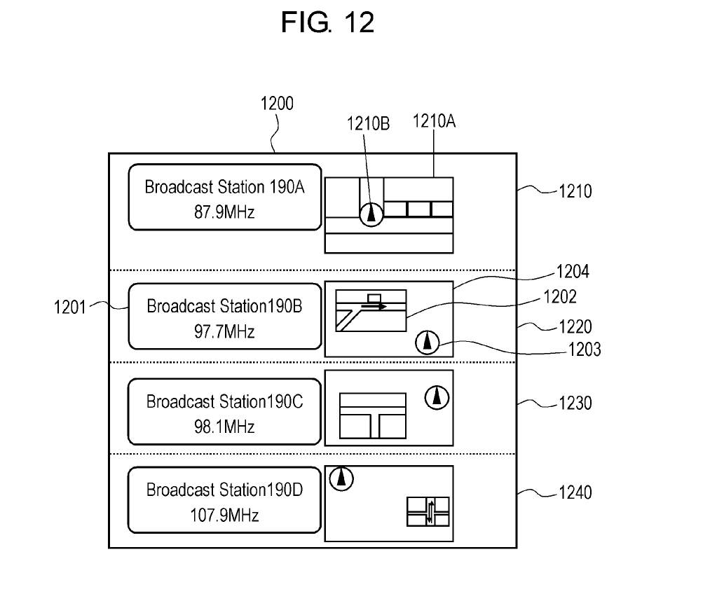

FIG. 12 shows tuning screen 1200 generated in receiving device 1000 in accordance with Embodiment 3.

Tuning screen generator 1005 divides the display screen of display unit 107A of input/output unit 107 into one or more display regions, and displays the broadcast stations on the divided display regions. One receivable broadcast station is displayed on one display region.

Tuning screen 1200 includes four display regions 1210, 1220, 1230, and 1240.

One receivable broadcast station, for example, the broadcast station indicated in display region 1220 is displayed with frequency information segment 1201, map image 1202 generated from the map image information segment, and icon 1203 that is an image indicating the current position.

One display region includes a map image display region for displaying a map image and an icon that indicates a current position. On tuning screen 1200 shown in FIG. 12, display region 1220 includes map image display region 1204 for displaying map image 1202 and icon 1203 that indicates the current position. In the map image display region, the map image and the icon that indicates the current position are displayed with latitudes and longitudes. That is, the map image and the icon that indicates the current position are displayed based on a positional relationship between the current position and the position indicated by the map image, and specifically, the map image and the icon are displayed while maintaining a relative positional relationship between the position indicated by the map image and the current position. An arrow of icon 1203 that indicates the current position shows a moving direction in which receiving device 1000 moves.

As mentioned above, tuning screen 1200 includes one or more frequency information segments 1201, one or more map images 1202, and an indication (icon 1203) which indicates the current position. The indication is disposed based on positional relationships between the current positions and one or more positions indicated by one or more map images 1202. One or more map images 1202 and the indication (icon 1203) which indicates the current position are displayed on tuning screen 1200 while maintaining relative positional relationships between the current position and the one or more positions indicated by one or more map images 1202.

Tuning screen generator 1005 reduces the map images so that the icon which indicates the current position and the map images can fit in the map image display region.

A process for reducing the map images performed by tuning screen generator 1005 will be described below.

Tuning screen generator 1005 reduces the map images so that all of the icon which indicates the current position and the map images can be displayed, and that the map images can be displayed to be as large as possible.

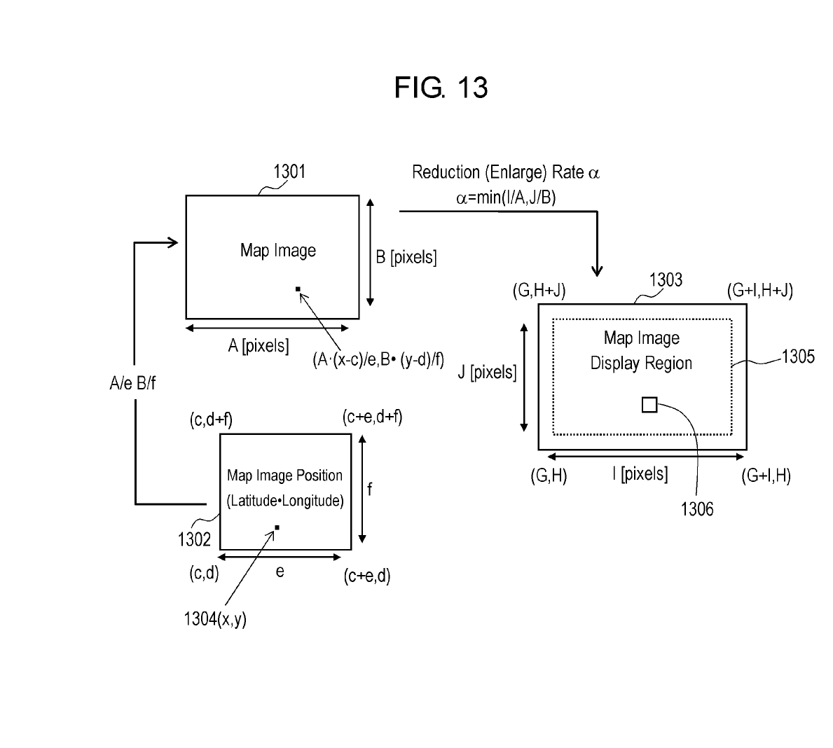

FIG. 13 illustrates the reducing process in the case that the current position is in the rectangular region showing the map image therein. FIG. 13 illustrates the reducing process in order to display map image 1301 in map image display region 1303 with map image position 1302.

In FIG. 13, an upper side in map image 1301 indicates north. Map image 1301 has lateral size A [pixels] and longitudinal size B [pixels]. Map image position 1302 that indicates a rectangular region shown by map image 1301 is d to (d+f) degrees north latitude and c to (c+e) degrees east longitude.

That is, map image 1301 shows a rectangular region having four vertexes, (c degrees, d degrees), ((c+e) degrees, d degrees), (c degrees, (d+f) degrees), ((c+e) degrees, (d+f) degrees) as map image position 1302.

In the display region composed of plural pixels arranged longitudinally and laterally on the display screen of display unit 107A, map image display region 1303 is a rectangular region with lateral size I [pixels] and longitudinal size J [pixels] having four vertexes, (G, H) [pixel], (G+I, H) [pixel], (G, H+J) [pixel] and (G+I, H+J) [pixel]. The size of a current-position icon that indicates the current position is (2·K, 2·K) [pixels]. Current position 1304 is (x degrees, y degrees), that is, y degrees north latitude and x degrees east longitude. (where f>0, e>0, G≧0, H≧0, I>0, J>0, K>0, I>>2·K, J>>2·K).

In the case that the current position is inside the rectangle of the map image and is not located on an end of the rectangle, tuning screen generator 1005 reduces map image 1301 to allow map image 1301 to match with the map image display region, and displays the icon which indicates the current position while superimposing the icon on the current position.

That is, in the case that the current position is included in a display region of rectangle 1305 having four vertexes (G+K, H+K) [pixel], (G+I−K, H+K) [pixel], (G+K, H+J−K) [pixel], and (G+I−K, H+J−K) [pixel], the icon that indicates the current position is located not out of map image display region 1303, and accordingly, by only reducing the map image to allow the map image to match with the display region, the map image and the icon can be displayed in the map image display region. A reduction rate α (>0) of the map image is the smallest value of between I/A and J/B, that is, α=min(I/A, J/B).

When current position 1304 is expressed by a position on the map image before the reduction, the position is expressed as (A·(x−c)/e, B·(y−d)/f) [pixel], and accordingly, the current position in the map image display region is (G+α·A·(x−c)/e, H+α·B·(y−d)/f) [pixel].

Hence, in the case that the relations, G+K<G+α·A·(x−c)/e<G+I−K and H+K<H+α·B·(y−d)/f<H+J−K are satisfied, that is, in the case that the relations, K·e/(α·A)+c<x<(I−K)·e/(α·A)+c and K·f/(α·B)+d<y<(J−K)·f/(α·B)+d are satisfied, tuning screen generator 1005 enlarges the map image by a times to allow the map image to match with the display region. In the case that the position of (0, 0) [pixel] of the map image is a position of the display region (G, H) [pixel], the center of the current-position icon 1306 is located at (G+αA·(x−c)/e, H+α·B·(y−d)/f) [pixel], and is displayed.

For example, a region indicated by the map image included in the data broadcast transmitted from broadcast station 190A shown in FIG. 11 is a range from 135.00000 degrees east longitude to 135.08784 degrees east longitude and a range from 35.00000 degrees north latitude to 35.05397 degrees north latitude. The map image is composed of pixels which are a product of 800 pixels (a lateral size) and 600 pixels (a longitudinal size). Map image display region 1210A in display region 1210 indicating broadcast station 190A shown in FIG. 12 is a rectangular display region having four vertexes (600, 1000) [pixel], (1000, 1000) [pixel], (600, 1300) [pixel], and (1000, 1300) [pixel]. The size of icon 1210B that indicates the current position is (100, 100) [pixels]. That is, K=50 is established. The current position is a position (135.02928 degrees east longitude, 35.02699 degrees north latitude.

In this case, the reduction rate α of the map image is α=min(I/A, J/B)=min((1000−600)/800, (1300−1000)/600)=min(400/800, 300/600)=0.5. Since the relations, K·e/α·A+c<x<(I−K)·e/(α·A)+c and K·f/(α·B)+d<y<(J−K)·f/(α·B)+d, that is 0.01098+135.00000<135.02928<0.07686+135.0000 and 0.00900+35.00000<35.02699<0.04498+35.00000 are satisfied, when tuning screen generator 1005 reduces the map image by 0.5 times to the map image to match with the map image display region while (0, 0) [pixel] of the map image coincides with (600, 1000) [pixel] of the display region, similarly to broadcast station 190A shown in FIG. 12, the center of icon 1210B that indicates the current position is displayed at display region (733, 1150) [pixel].

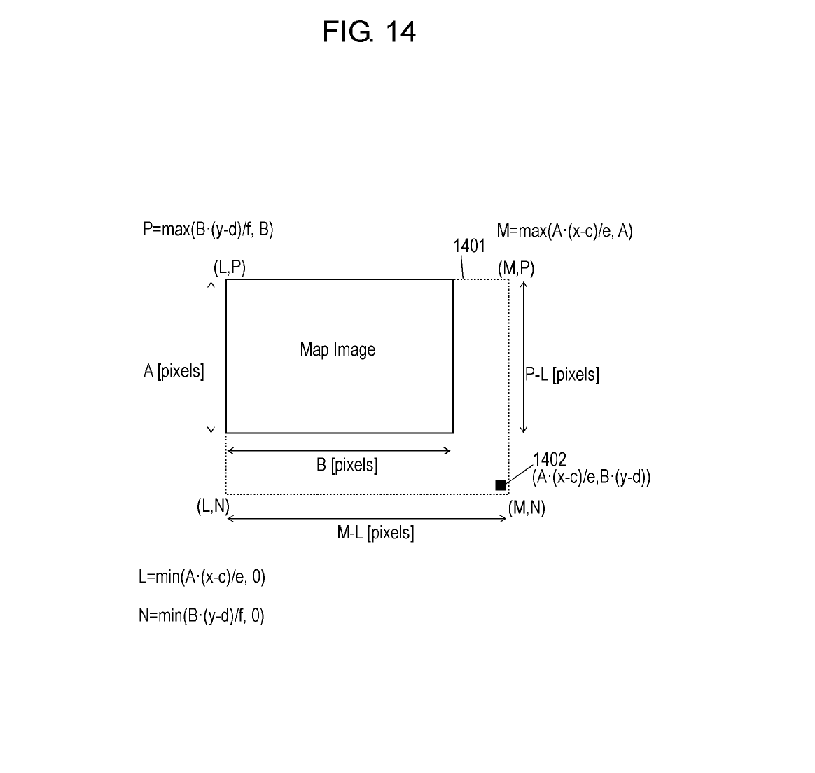

FIG. 14 illustrates the reduction in the case that the current position is not located inside the rectangle shown by the map image, that is, the case that the current position is located outside the rectangle. The sizes of map image 1301 and map image display region 1303 shown in FIG. 14 are the same as map image 1301 and map image display region 1303 shown in FIG. 13.

In that case that the current position is not included in the region of rectangle 1305 shown by map image 1301 shown in FIG. 13, smallest rectangle 1401 that includes all of the map images and the current position is generated from positional relationship between the current position and the position indicated by the map image before the reduction. When current position 1402 is expressed by the position of the map image before the reduction as (A·(x−c)/e, B·(y−d)/f) [pixel], and accordingly, the smallest rectangle is rectangle 1401 having four vertexes, (L, N) [pixel], (M, N) [pixel], (L, P) [pixel], and (M, P) [pixel], with a minimum number L (=min(A·(x−c)/e, 0)) out of a value (A·(x−c)/e) and 0, a maximum value M (=max(A·(x−c)/e, A)) out of a value (A·(x−c)/e) and a value A; a minimum value N (=min(B·(y−d)/f, 0)) out of a value (B·(y−d)/f) and 0; and a maximum value P (=max(B·(y−d)/f, B)) out of a value (B·(y−d)/f) and a value B.

The image of rectangle 1401 is reduced to allow the image to match with map image display region 1303. However, if the image of rectangle 1401 is directly reduced such that a longitudinal side or lateral side of the image coincides with that of map image display region 1303, the icon that indicates the current position can hardly be visible and is located out of map image display region 1303, Tuning screen generator 1505 consequently reduces the image by a reduction rate β to allow the image to match with rectangle 1305 having four vertexes (G+K, H+K) [pixel], (G+I−K, H+K) [pixel], (G+K, H+J−K) [pixel], and (G+I−K, H+J−K) [pixel] in map image display region 1303.

The reduction rate β of the map image is obtained by β=min((I−2·K)/(M−L), (J−2·K)/(P−N)). Hence, such a rectangle obtained by superimposing the current position on the map image is reduced by β times to allow the map image to match with the display region, and the position (L, N) [pixel] coincides with the position (G+K, H+K) [pixel] of the display region (G+K, H+K) [pixel], thereby disposing the reduced map image in rectangle 1401. In map image display region 1303, tuning screen generator 1505 displays icon 1203 that indicates the current position while the center of icon 1203 coincides with the position (β·(A·(x−c)/e−L)+G+K, β·(B·(y−d)/f−N)+H+K) [pixel].

For example, the map image in the data broadcast transmitted from broadcast station 190B shown in FIG. 12 shows a region ranging from 134.91219 degrees east longitude to 134.99999 degrees east longitude and from 35.05398 degrees north latitude to 35.10795 degrees north latitude, and is composed of pixels as a product of 800 pixels (a lateral size) and 600 pixels (a longitudinal size). The display region of the screen is a rectangular display region having vertexes (600, 1000) [pixel], (1000, 1000) [pixel], (600, 1300) [pixel], and (1000, 1300) [pixel]. The size of icon 1203 that indicates the current position is (100, 100) [pixels], that is, a product of 100 [pixels] (a longitudinal size) and 100 [pixels] (a lateral size). The current position is located outside the region shown in the map image, that is, located at the position of 135.02928 degrees east longitude and 35.02699 degrees north latitude.

At this moment, the reduction rate α for displaying the map image in map image display region 1204 at maximum is α=min(400/800, 300/600)=0.5. In the case that the relation x≦K·e/(α·A)+c, or (I−K)·e/(α·A)+c≦x, or y≦K·f/(α·B)+d, or (J−K)·f/(α·B)+d≦y is satisfied, the current position is located outside the map image. Accordingly, tuning screen generator 1505 reduces the map image such that icon 1203 that indicates the current position is be displayed in map image display region 1204.

In this example, the relations, 0.07686+134.91219≦135.02928 and 35.02699≦0.00900+35.05398 are established, and accordingly, the smallest rectangle that includes all of the map image and the current position is generated from the positional relationship between the position indicated by the map image before the reduction and the current position.

When the current position is expressed as the position in the map image before the reduction, the current position is expressed as (1067, ?300) [pixel], and accordingly, the smallest rectangle becomes a rectangle having four vertexes (L, N) [pixel], (M, N) [pixel], (L, P) [pixel], and (M, P) [pixel], where L=min(1067, 0), M=max(1067, 800), N=min(−300, 0), and P=max(−300, 600), and specifically, becomes a rectangle having four vertexes located at (0, −300) [pixel], (1067, −300) [pixel], (0, 600) [pixel] and (1067, 600) [pixel].

If the image of rectangle 1401 is directly reduced such that a longitudinal side or a lateral side of the image coincides with that of map image display region 1303, icon 1203 that indicates the current position can hardly be visible and is out of the region. Accordingly, tuning screen generator 1505 reduces the image by a reduction rate β to allow the map image to match with a rectangle having four vertexes (G+K, H+K) [pixel], (G+I−K, H+K) [pixel], (G+K, H+J−K) [pixel], and (G+I−K, H+J−K) [pixel], that is, four vertexes (650, 1050) [pixel], (950, 1050) [pixel], (650, 1250) [pixel], and (950, 1250) [pixel].

The reduction rate β of the map image is β=min((I−2·K)/(M−L), (J−2·K)/(P−N))=min(300/1067, 200/900)=0.22222. Hence, the rectangle including the current position superimposed on the map image is reduced by 0.22222 times to allow the map image to match with the display region, and the position (0, −300) [pixel] in the rectangle coincides with (650, 1050) [pixel] in the map image display region such that rectangle 1401 is disposed in the map image display region. That is, the map image of the data broadcast transmitted from broadcast station 190B shown in FIG. 12 is reduced and displayed on a rectangular region having vertexes, (650, 1117), (828, 1117), (650, 1250), and (828, 1250) in the map image display region while the center of icon 1203 that indicates the current position coincides with (887, 1050) [pixel] in the map image display region to display icon 1203 that indicates the current position.

As described above, in receiving device 1000 according to Embodiment 3 that does not include map data, the user can tune a the broadcast station based on the map images by utilizing the received data of the data broadcast.

Tuning screen generator 1005 displays the tunable broadcast station on the tuning screen including the frequency information segment and the image in which the map image and the icon that indicates the current position are disposed based on the current position and the position information segment of the map image. The relationship with the current position on the tuning screen allows the user to clearly realize the position of the map image, that is, the service area of the broadcast.

In receiving device 1000 that does not include the map data, allows the user to acquire the desired information segment by tuning the broadcast station based on the map image and the relationship between the map image and the current position.

The operation of the reduction of receiving device 1000 in accordance with Embodiment 3 is merely an example for displaying the map image and the icon that indicates the current position in the map image display region. For example, only an orientation relationship between the map image and the current position may be displayed correctly. Moreover, the reduction rate of the map image may be a value other than the reduction rate of the distance between the map image and the current position, and the map image and the icon of the current position may be displayed. The distance between the map image and the current position may be displayed as a numeric value. Such a display mode of the map image and the icon that indicates the current position, the display mode being based on the positional relationship between the position indicated by the map image and the current position is not limited to the reduction thus illustrated.

Receiving device 1000 in accordance with Embodiment 3 is not only implemented by dedicated hardware, but also by a program for performing the above control method recorded in a computer-readable recording medium and by a computer reading the recorded program and executing the read program.

### Exemplary Embodiment 4

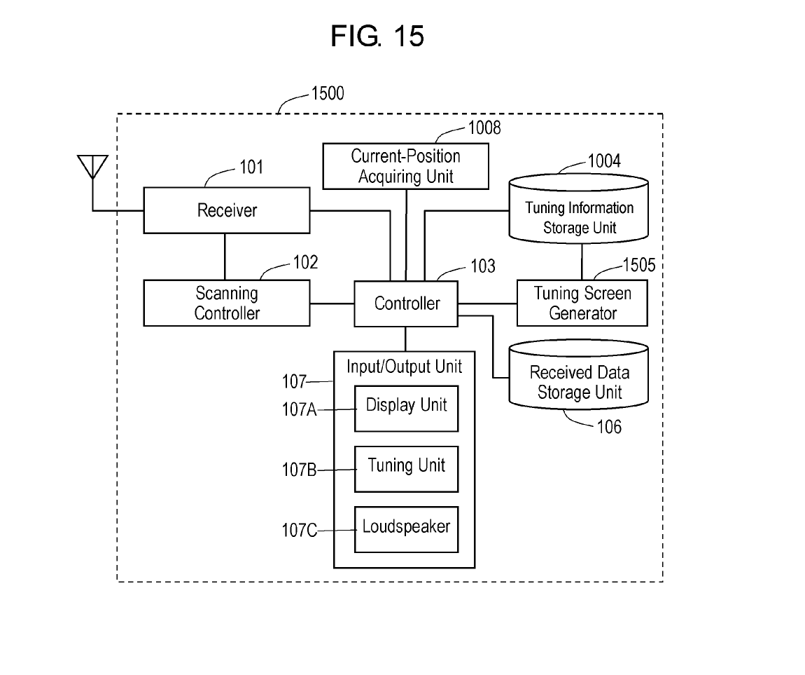

FIG. 15 is a block diagram of receiving device 1500 in accordance with Exemplary Embodiment 4. In FIG. 15, constituents identical to those of receiving device 1000 according to Embodiment 3 shown in FIG. 10 are denoted by the same reference numerals.

A difference of receiving device 1500 according to Embodiment 4 from receiving device 1000 according to Embodiment 3 is that tuning screen generator 1505 generates the tuning screen from plural map images and the icon that indicates the current position.

Tuning screen generator 1505 acquires the current position of receiving device 1500 from current-position acquiring unit 1008 when generating the tuning screen, and generates the tuning screen from the acquired current position and the tuning information segment stored in tuning-information storage unit 1004.

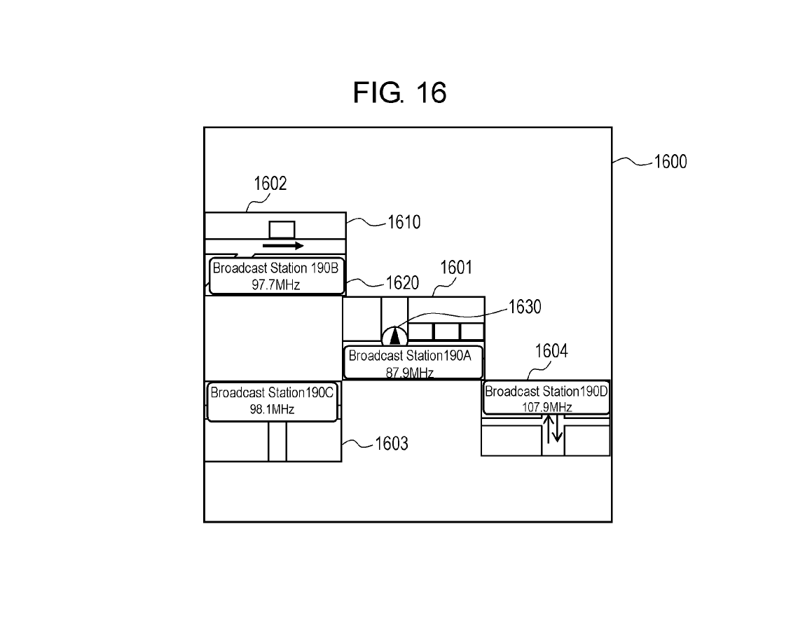

FIG. 16 shows the tuning screen generated by tuning screen generator 1505 of receiving device 1500 in accordance with Embodiment 4.

Tuning screen 1600 shows four receivable broadcast stations 1601, 1062, 1603, and 1604. On tuning screen 1600, the receivable broadcast station, for example, broadcast station 1602 is displayed as an image having frequency information segment 1620 superimposed on map image 1610.

On tuning screen 1600, the position of each of the map images and the position of icon 1630 that indicates the current position are displayed based on latitude and longitude. That is, each of the map images and the icon that indicates the current position are displayed based on a positional relationship between the current position and the position indicated by the map image, that is, while maintaining the relative positional relationship between the current position and the position indicated by the map image.

As mentioned above, the tuning screen 1600 includes an indication (icon 1630) indicating the current position and plural map images 1610 disposed based on positional relationship between the current position and each of positions indicated by the map images 1610, the frequency information segments 1620 each superimposed on respective one of the plural map images 1610.

Tuning screen generator 1505 reduces the map images of the respective broadcast stations such that the map images and the icon that indicates the current position are displayed on the display screen of display unit 107A of input/output unit 107. Tuning screen generator 1505 reduces the map images such that the map images are displayed as large as possible.

A reducing process performed by tuning screen generator 1505 to display two map images 1701 and 1702 will be described below.

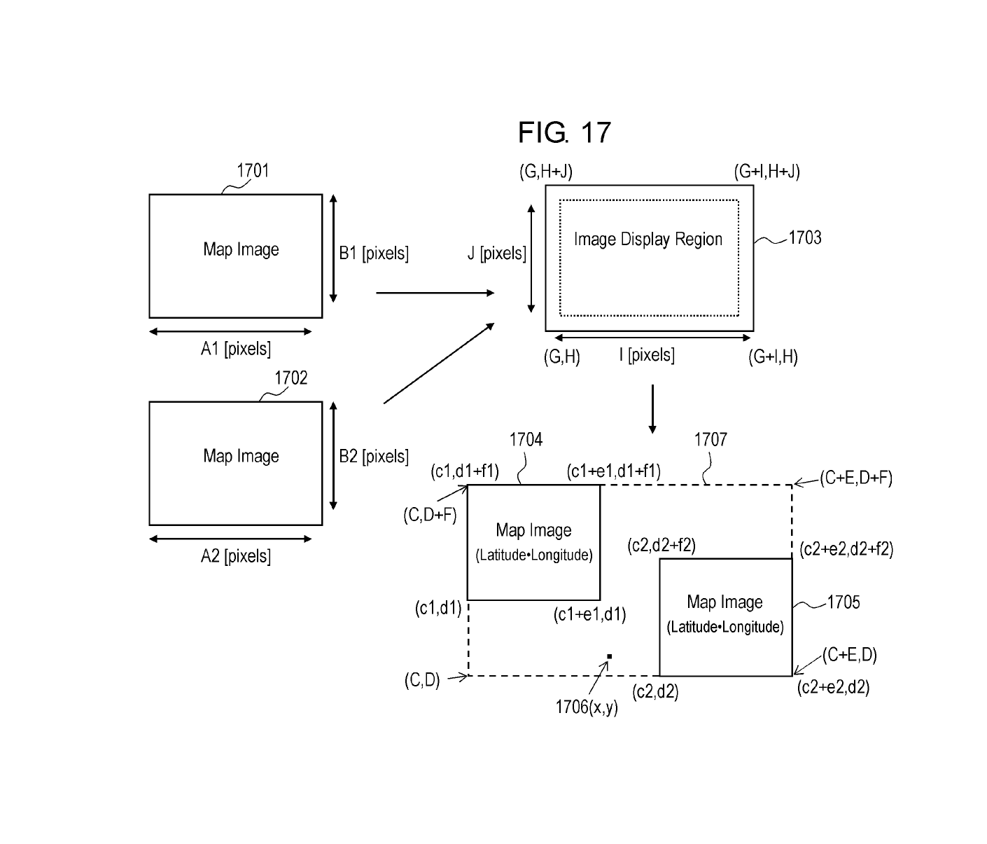

FIG. 17 illustrates the reduction in the case that the current position is located inside the smallest rectangle including map images 1701 and 1702 which show the broadcast stations. The reduction is performed by tuning screen generator 1505 of receiving device 1500 in accordance with Embodiment 4.

FIG. 17 shows the reduction in that case that current position 1706 is located in smallest rectangle 1707 including map images 1701 and 1702.

A calculation method is substantially identical to that of Embodiment 3. Upper sides of the map images indicate north. Map image 1701 of each broadcast station has a lateral size A1 [pixels] and a longitudinal size B1 [pixels] while map image 1702 has a lateral size A2 [pixels] and a longitudinal size B2 [pixels]. The position indicated by map image 1701 ranges from d1 degrees north latitude to (d1+f1) degrees north latitude and from c1 degrees east longitude to (c1+e1) degrees east latitude while the position indicated by map image 1702 ranges from d2 degrees north latitude to (d2+f2) degrees north latitude and from c2 degrees east longitude to (c2+e2) degrees east latitude.

That is, map image 1701 shows a region expressed by rectangle 1704 having four vertexes (c1 degrees, d1 degrees), ((c1+e1) degrees, d1 degrees), (c1 degrees, (d1+f1) degrees) and ((c1+e1) degrees, (d1+f1) degrees). Map image 1702 shows a region expressed by rectangle 1705 having four vertexes (c2 degrees, d2 degrees), ((c2+e2) degrees, d2 degrees), (c2 degrees, (d2+f2) degrees) and ((c2+e2) degrees, (d2+f2) degrees).

Map image display region 1703 of the tuning screen is a rectangular region having four vertexes (G, H) [pixel], (G+I, H) [pixel], (G, H+J) [pixel], and (G+I, H+J) [pixel]. The size of a current-position icon is (2·K, 2·K) [pixels], that is, the icon is a rectangular region having a longitudinal size of 2·K [pixels] and a lateral size of 2·K [pixels]. Current position 1706 is (x, y), that is x degrees north latitude and y degrees east longitude (where f1>0, e1>0, f2>0, e2>0, G≧0, H≧0, I>0, J>0, K>0, I>>2·K, J>>2·K). Rectangle 1707 is a minimum rectangle that includes map images 1701 and 1702 which show the broadcast stations. The minimum rectangle is obtained by causing the scales of map images 1701 and 1702 to coincide with each other while maintaining relative positional relationship between map images 1701 and 1702. In the case that the current position is located inside rectangle 1707 and is not located on an end of rectangle 1707, tuning screen generator 1505 generates an image including map images 1701 and 1702 of the broadcast stations while causing scales of the map images with each other and maintaining the positional relationship between the map images, reduces the generated image obtained by adding map images 1701 and 1702 to each other to allow the generated image to match with map image display region 1703, and displays the icon that indicates current position 1706 while superimposing the icon on current position 1706.

Rectangle 1707 becomes a rectangle having four vertexes (C, D), (C+E, D), (C, D+F), and (C+E, D+F), wherein C=min(c1, c2), D=min(d1, d2), C+E=max(c1+e1, c2+e2), and D+F=max(d1+f1, d2+f2). While reducing map images 1701 and 1702, tuning screen generator 1505 displays map images 1701 and 1702 on positions corresponding to map images 1701 and 1702 in rectangle 1707.

Reduction rate α1 of map image 1701 is obtained by α1=min(I·e1/(E·A1), J·f1/(F·B1)) while reduction rate α2 of map image 1702 is obtained by α2=min(I·e2/(E·A2), J·f2/(F·B2)). The position of (α1·A1·(c1−C)/e1+G, α1·B1·(d1−D)/f1+H) [pixel] in rectangle 1707 coincides with a position c1, d1) of map image 1701 while the position of (α2·A2·(c2−C)/e2+G, α2·B2·(d2−D)/f2+H) [pixel] in rectangle 1707 coincides with the position (c2, d2) in map image 1702, and thereby, tuning screen generator 1505 generates a tuning screen including rectangle 1707 including map images 1701 and 1702.

The current position in map image display region 1703 is (α1·A1·(x−C)/e1+G, α1·B1·(y−D)/f1+H) [pixel]. Accordingly, in the case that the relations of K<α1·A1·(x−C)/e1<I−K and K<α1·B1·(y−D)/f1<J−K, are satisfied, that is, in the case that the relations of K·e1/(α1·A1)+C<x<(I−K)·e1/(α1·A1)+C and K·f1/(α1·B1)+D<y<(J−K)·f1/(α1·B1)+D are satisfied, as described above, tuning screen generator 1505 allows the center of the icon that indicates the current position to coincide with the position of (α1·A1·(x−c)/e1+G, α1·B1·(y−D)/f1+H) [pixel] in map image display region 1703, and displays the icon while superimposing the icon on the map image.

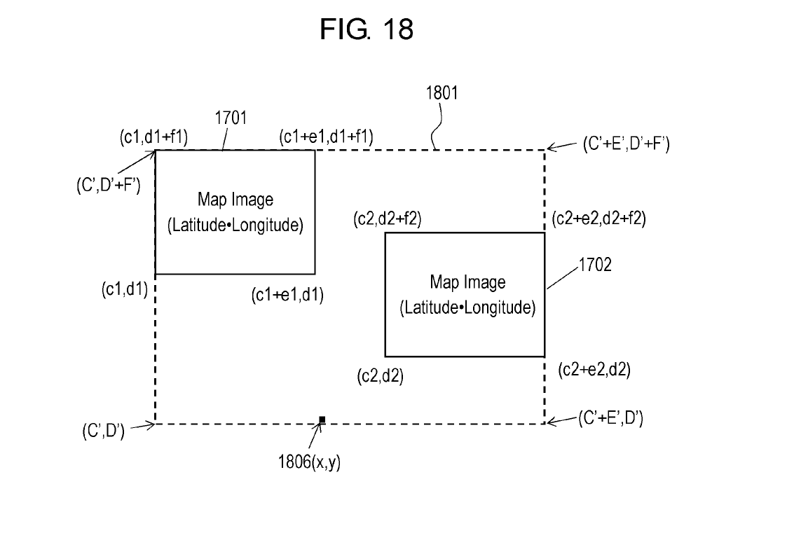

FIG. 18 illustrates a reducing process performed in the case that the current position is located outside smallest rectangle 1707 including map images 1701 and 1702 showing the broadcast stations. The reducing process is performed by tuning screen generator 1505 of receiving device 1500 in according to Embodiment 4.

Map images 1701 and 1702 are the same as those shown in FIG. 17. In the case that current position 1806 is located outside smallest rectangle 1707 that includes the map images which show the broadcast stations, then as shown in FIG. 18, tuning screen generator 1505 generates a smallest rectangle 1801 that includes all of map images 1701 and 1702 and the current position based on relative positional relationships between the current position and each of the positions indicated by map images 1701 and 1702 of the respective broadcast stations before the reduction.

Rectangle 1801 has four vertexes (C′, D′), (C′+E′, D′), (C′, D′+F′) and (C′+E′, D′+F′) with a minimum value C′ (=min(x, c1, c2)) among values x, c1 and c2, a minimum value D′ (=min(y, d1, d2)) among values y, d1 and d2, a maximum value (C′+E′) (=max(x, c1+e1, c2+e2) among values x, (c1+e1) and (c2+e2), and a maximum value (D′+F′) (=max(y, d1+f1, d2+f2) among values y, (d1+f1) and (d2+f2).

The image of rectangle 1801 is reduced to allow the image to match with the display region of display unit 107A. However, if the image of rectangle 1801 is directly reduced such that a longitudinal side or lateral side of the image coincides with that of the display region of display unit 107A, the icon that indicates the current position can be hardly visible and is out of the image. Tuning screen generator 1505 reduces map images 1701 and 1702 at reduction rates β1 and β2, respectively so that map images 1701 and 1702 can be displayed in rectangle 1801 which is a rectangular region having four vertexes (G+K, H+K) [pixel], (G+I−K, H+K) [pixel], (G+K, H+J−K) [pixel] and (G+I−K, H+J−K) [pixel].

Reduction rates β1 and β2 of map images 1701 and 1702 are obtained by β1=min((I−2·K)·e1/(E′·A1), (J−2·K)·f1/(F·?B1)) and β2=min((I−2·K)·e2/(E′·A2), (J−2·K)·f2/(F·?B2)). The position (β1·A1·(c1−c′)/e1+G+K, β1·B1·(d1−D′)/f1+H+K) [pixel] in rectangle 1801 coincides with a position (c1, d1) of map image 1701 while a position (β2·A2·(c2−C′)/e2+G+K, β2·B2·(d2−D′)/f2+H+K) [pixel] in rectangle 1801 coincides with a position (c2, d2) in map image 1702, thereby allowing tuning screen generator 1505 to display map images 1701 and 1702 in rectangle 1802.

The center of the icon that indicates the current position coincides with the position (β1·A1·(x−C′)/e1+G+K, β1·B1·(y−D′)/f1+H+K) [pixel] in rectangle 1801, thereby allowing the icon to be displayed while being superimposed on map images 1701 and 1702 displayed on rectangle 1801.

As described above, in receiving device 1500 according to Embodiment 4, tuning screen generator 1505 generates the tuning screen including plural map images 1701 and 1702 and the icon that indicates current position 1706 (1806) based on the relationships between the current position and each of the map images. The positional relationship of the respective map images becomes clear with respect to the current position.

In receiving device 1500 that does not include map data, the user can tune the broadcast station which transmits the desired information segment from plural map images of which positional relationships with the current position become clear.

All of the receivable broadcast stations are displayed, whereby, without scrolling the display screen, the user can tune the broadcast station which transmits a desired information segment from all of the receivable broadcast stations.

In the case that a map image added with different information, such as traffic congestion information and weather information is broadcast, receiver 101 distinguishes the map images by the added information, and stores the map images in tuning-information storage unit 1004, and tuning screen generator 1505 generates the tuning screen by using map images added with the same type of information. This configuration allows the user to tune a broadcast station transmitting specific additional information.

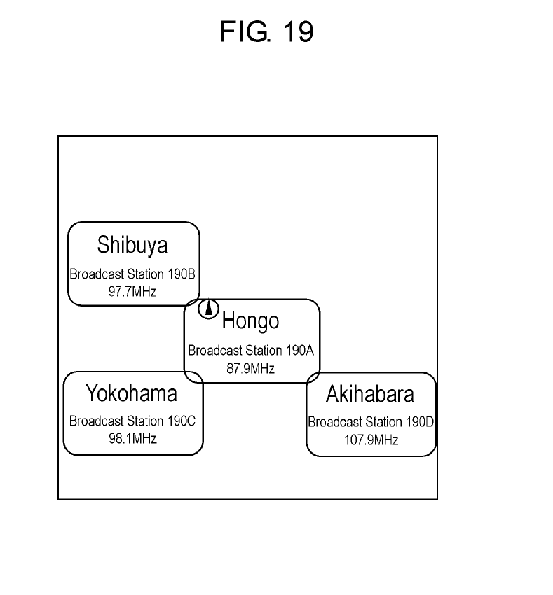

Moreover, the tuning screen may be generated by using an area name that is a name of an area shown by the map image in place of the map image. FIG. 19 shows a tuning screen in which the broadcast stations are displayed by using area names of areas, which are shown by map images, in place of the map images. It becomes possible for the user to select the broadcast station, which is transmitting the desired information, from a plurality of the area names, in each of which the relationship with the current position has become clear.

The operation of the reducing process of receiving device 1500 in accordance with Embodiment 4 is just an example of the operation of displaying plural map images and the icon that indicates the current position on the map image display region. For example, only orientation relationships between the current position and each of plural map images may be displayed correctly. The reduction rate of the map images may be determined to be a value other than the reduction rate of the distance between the current position and each of the plural map images. This configuration allows the plural map images and the icon of the current position to be displayed. Moreover, the distances between the current position and each of the plural map images may be expressed as numeric values. Such a display mode of the plural map images and the icon that indicates the current position based on the positional relationships between the positions indicated by the plural map images and the current position are not limited to the reduction thus illustrated.

Moreover, receiving device 1500 in accordance with Embodiment 4 is not only implemented by dedicated hardware, but also by a program for performing the above control method recorded in a computer-readable recording medium, and a computer having the recorded program to be read by the computer executed.

### INDUSTRIAL APPLICABILITY

A receiving device according to the present invention is useful as a receiving device installed to a movable body, such as a vehicle, and receives data broadcast.

### REFERENCE MARKS IN THE DRAWINGS

100, 800, 1000, 1500 receiving device
101, 1001 receiver
102, 802 scanning controller
103, 803 controller
104, 1004 tuning-information storage unit
105, 1005, 1505 tuning screen generator
106 received-data storage unit
107 input/output unit
808 audio broadcast receiver
809 audio broadcast receiver
1008 current-position acquiring unit

1. A receiving device that does not include map data, the receiving device comprising:
a receiver that receives one or more map images;
a tuning-information storage unit that stores the one or more map images and one or more frequency information segments received from one or more broadcast stations such that each of the one or more map images is linked to respective one of the one or more frequency information segments, each of the one or more frequency information segments indicating a frequency of respective one of the one or more broadcast stations;
a tuning screen generator that generates a tuning screen displaying thereon the one or more broadcast stations with the one or more frequency information segments stored in the tuning-information storage unit and with the one or more map images linked to the one or more frequency information segments;
a display unit that displays the tuning screen; and
a tuning unit that tunes a broadcast station out of the one or more broadcast stations received by the receiver from the tuning screen displayed on the display unit.

2. A receiving device that does not include map data, the receiving device comprising:
a receiver that receives one or more broadcasts including one or more map image information segments, respectively;
a scanning controller that controls the receiver such that the receiver sequentially changes a receiving frequency received by the receiver and sequentially receives one or more broadcast stations;
a tuning-information storage unit that stores the one or more map image information segments and one or more frequency information segments each indicating a frequency of respective one of the one or more broadcast stations received by the receiver controlled by the scanning controller, such that each of the one or more map image information segments is linked to respective one of the one or more frequency information segments;
a tuning screen generator that generates a tuning screen displaying thereon at least one broadcast station out of the one or more broadcast stations which has a frequency indicated by at least one frequency segment with a group including the at least one frequency information segment out of the one or more frequency information segments and at least one map image out of one or more map images based on the one or more map image information segments out of one or more groups each including respective one of the one or more frequency information segments of the one or more broadcast stations and respective one of the one or more map image information segments stored in tuning-information storage unit,
a display unit that displays the tuning screen; and
a tuning unit that tunes a broadcast station out of the one or more broadcast stations on the tuning screen displayed on the display unit.

3. The receiving device according to claim 2, further comprising
an audio broadcast receiver capable of receiving an audio broadcast and the one or more broadcasts,
wherein the scanning controller controls the audio broadcast receiver to allow the audio receiver to sequentially change a receiving frequency of the audio broadcast receiver to sequentially receive the one or more broadcast stations, and
wherein the tuning-information storage unit stores the map image information segments and the one or more frequency information segments of the one or more broadcast stations received by the audio broadcast receiver under control of the scanning controller such that each of the one or more frequency information segments is linked to respective one of the map image information segments.

4. The receiving device according to claim 2, further comprising
a current-position acquiring unit that acquires a current position,
wherein the tuning screen includes the one or more frequency information segments, the one or more map images, and an indication that indicates the current position, the indication being disposed based on positional relationship between the current position and each of one or more positions indicated by the one or more map images.

5. The receiving device according to claim 2, further comprising
a current-position acquiring unit that acquires a current position,
wherein the one or more broadcast stations comprise a plurality of broadcast stations,
wherein the one or more frequency information segments comprise a plurality of frequency information segments indicating frequencies of the plurality of broadcast stations,
wherein the one or more map images comprise a plurality of map images, and
wherein the tuning screen includes an indication indicating the current position and a plurality of map images disposed based on positional relationship between the current position and each of positions indicated by the plurality of map images, the plurality of frequency information segments each superimposed on respective one of the plurality of map images.

6. A method of controlling a receiving device that does not include map data, the method comprising:
sequentially changing a receiving frequency and sequentially receiving one or more receivable broadcasts;
storing one or more frequency information segments of the one or more receivable broadcasts together with one or more map image information segments after extracting the one or more map image information segments from the one or more receivable broadcasts, each of the one or more map image information segments being linked to respective one of the one or more frequency information segments;
generating a tuning screen displaying thereon the one or more receivable broadcast stations with the stored one or more frequency information segments and the one or more map images from one or more groups each including respective one of the stored one or more frequency information segments and respective one of the one or more map image information segments each linked to respective one of the stored one or more frequency information segments; and
displaying the generated tuning screen.

7. A method of controlling a receiving device that does not include map data, the method comprising:
sequentially receiving one or more receivable broadcasts by sequentially changing a receiving frequency;
storing one or more frequency information segments indicating one or more frequencies of the one or more receivable broadcasts together with one or more map image information segments after extracting the one or more map image information segments from the one or more receivable broadcasts, each of the one or more map image information segments being linked to respective one of the one or more frequency information segments;
acquiring a current position;
generating a tuning screen displaying thereon the one or more receivable broadcasts with the one or more frequency information segments, the one or more map images, and an image showing the current position disposed based on positional relationship between the current position and a position indicated by each of the one or more map images; and
displaying the generated tuning screen.

8. A method of controlling a receiving device that does not include map data, the method comprising:
sequentially receiving a plurality of receivable broadcasts by sequentially changing a receiving frequency;
storing a plurality of frequency information segments each indicating a frequency of respective one of the one or more receivable broadcasts together with a plurality of map image information segments after extracting the plurality of map image information segments from the plurality of receivable broadcasts;
acquiring a current position;
generating a tuning screen including a plurality of map images and an image indicating the current position, the plurality of map images being arranged based on positional relationship between the current position and each of positions of the plurality of map images indicated by the plurality of map image information segments, the frequency information segments being superimposed on the plurality of the map images, the tuning screen being generated by superimposing each of the plurality of frequency information segments on respective one of the plurality of map images; and
displaying the generated tuning screen.

9. A program for allowing a computer to execute the method according to claim 7.

10. A computer-readable recording medium that records the program according to claim 9.

11. A program for allowing a computer to execute the method according to claim 8.

12. A computer-readable recording medium that records the program according to claim 11.
